(19) United States
(12) Patent Application Publication
(10) Pub. No.: US 2026/0244477 A1
(43) Pub. Date: Aug. 20, 2026

(54) Preventing Unauthorized Remote Input Using Vibration-Based Authentication

(71) Applicant: NATHAN SCOTT, MUKILTEO, WA (US)

(72) Inventor: NATHAN SCOTT, MUKILTEO, WA (US)

(21) Appl. No.: 19/054,956

(22) Filed: Feb. 17, 2025

(51) Int. Cl. G06F 9/455; G06F 21/31; G06F 21/64

(52) U.S. Cl. CPC G06F 9/45558; G06F 21/31; G06F 21/64; G06F 2009/45587

(57) ABSTRACT

A system and method for preventing unauthorized remote access using vibration-based authentication. The system includes a vibration sensor configured to capture keystroke vibrations. The captured data is analyzed to detect inconsistencies with digital input signals, ensuring that only physically present users can operate the device. If anomalies are detected, the system triggers security measures, such as lockdown and alerts.

### FIELD OF THE INVENTION

The present invention generally relates to computer security and authentication systems and, more specifically, to methods and apparatus for verifying the authenticity of user input devices—such as keyboards, mice, or touchpads—by correlating physical vibration signals generated from their mechanical actuation with corresponding digital input events captured by the operating system. This approach enables the detection of remote, simulated, or virtualized inputs, ensuring that only physically generated interactions—reflected in measurable vibration data—are recognized as valid user actions.

Moreover, the invention extends to environments where user inputs may originate from or traverse virtual machines (VMs) and virtual desktop infrastructure (VDI) systems. By integrating vibration sensor data (e.g., from MEMS accelerometers) with input monitoring software, the System can distinguish genuine physical interactions from those produced within a virtual or otherwise simulated context, thereby enhancing security across a broad range of computing platforms.

The invention is applicable to traditional desktops, laptops, and virtualized computing environments alike and can be implemented using integrated or external vibration sensors, including but not limited to MEMS accelerometers.

### BACKGROUND

With the rise of remote work and outsourcing, ensuring the authenticity of user interactions on computing devices has become a growing concern. Various entities, including individuals, institutions, and companies, often assign computing devices to personnel for professional tasks. These computing devices may include work computers, personal computers, or virtualized computing environments.

Traditionally, authentication mechanisms such as passwords, multi-factor authentication (MFA), and biometric verification are used to validate a user's identity at login. However, these methods fail to continuously verify that the authorized user remains the sole operator of the assigned device. Once authenticated, an authorized user may leave the workstation unattended or delegate work to an unauthorized individual, including remote freelancers or subcontractors, leading to potential security breaches.

In scenarios where sensitive information is processed, unauthorized remote access poses significant risks. For instance, an assigned computing device may be accessed remotely via remote desktop protocols (RDP), virtual machines (VMs), or other methods that do not require physical presence. While traditional behavioral analysis and anomaly detection techniques can help identify unusual activity, they often suffer from false positives and false negatives, as legitimate users may exhibit varying behaviors due to fatigue, stress, or environmental conditions.

To address this issue, the present invention introduces a system that integrates vibration sensor data with real-time monitoring software to continuously verify the authenticity of user inputs. The invention ensures that only physically present users can interact with assigned computing devices by correlating mechanical input vibrations with digital input events. This approach provides an effective security mechanism that prevents unauthorized remote operation, whether by remote attackers or unauthorized delegates.

Unlike prior authentication solutions that rely on behavioral biometrics, keystroke dynamics, or facial recognition, which can be spoofed or are prone to errors, this invention offers a robust hardware-assisted verification method. By leveraging physical sensor data rather than behavioral analytics, it ensures a more secure and reliable authentication process. The invention is applicable to various computing environments, including traditional desktops, laptops, and virtualized workspaces. It offers enhanced security for entities that require strict compliance with access policies, whether in corporate, institutional, or individual settings.

### BRIEF SUMMARY OF THE INVENTION

The present invention provides a method and system for continuously verifying the authenticity of user input across various computing devices, including devices assigned by an entity, an institution, or an individual. The system employs a vibration sensor—such as a MEMS accelerometer or IMU—integrated into or attached to these devices to capture mechanical actuation patterns and correlate them with digital input events.

By matching vibration signatures to corresponding input events, the system can determine whether an input is generated by an authorized, physically present user or by a remote, potentially unauthorized source. This authentication mechanism prevents security breaches caused by unauthorized access, including remote desktop exploitation, credential misuse, and insider threats. Additionally, this invention is particularly effective in client-server-based virtualized environments (e.g., virtual machines, remote desktop connections, and virtual desktop infrastructure (VDI)), where traditional input monitoring mechanisms fail to differentiate between real and simulated inputs. In this setup, users operate a remote work environment using a VibeLock-enabled client device, which securely transmits vibration authentication data to a server-side verification module (201E) deployed in a VM/VDI environment. The server, possessing a corresponding cryptographic key, verifies the authenticity of the input in real-time.

According to one aspect of the invention, the vibration sensor operates within a measurement range of ±2 g to ±8 g and a sampling rate between 200 Hz and 1 kHz, ensuring accurate detection of mechanical impulses while preventing data saturation or loss.

Overall, this invention offers a robust, hardware-assisted means of continuous user authentication, ensuring that only legitimate users can interact with computing devices assigned by an entity (101). It effectively mitigates cybersecurity risks associated with remote work environments while maintaining ease of use and operational efficiency.

### BRIEF DESCRIPTION OF THE DRAWINGS

FIG. 1 illustrates the overall system architecture and its application for security monitoring. The system consists of three primary entity levels: Company (101), Authorized Personnel (102), and Unauthorized Personnel (103). The manager (104) issues a work computer (201) to the employee (105), who interacts with the system. A vibration sensor (204) is used to capture input signals and transmits data (161) to the work computer (201). Additionally, a camera (203) may be utilized to capture video verification data (154). The employee's personal computer (202) may be connected for additional verification, and data is transmitted securely to a remote VM/VDI server (201E) for validation. In cases of unauthorized remote access (106), the system detects discrepancies between physical and digital inputs and can lock down the system (306) or notify IT administrators (405).

FIG. 2 provides an overview of how input data is processed through the system. Employee (105) provides input via connected hardware (200), which includes keyboards, mice, or other input devices. This data is transmitted to the Operating System Layer (300), where different modules handle the authentication process. The Sensor Level (160) consists of the vibration sensor (204), which captures physical input characteristics. The Operating System Level (300) processes the sensor data using a sensor driver (301) and input device driver (302). A monitoring software module (400) analyzes the sensor data through event analysis (303), HID input interception (305), and input decryption (402). If discrepancies are detected between the vibration data and digital input events, the OS Lockdown (306) may be triggered, or an alert may be sent to the IT administrator (405). The IT administrator is notified (405), and the system takes appropriate action, such as verifying additional inputs (406).

FIG. 3 shows how the vibration sensor (204) can be deployed across different computing devices, including: Tablet (201A), Laptop (201B), Desktop (201C) with External Mouse (201D), and VM/VDI Server (201E). Each device receives vibration sensor input (161) and transmits the data to an authentication server (201E) for validation. This ensures that input authentication can be applied across multiple environments, including both physical and virtual workspaces.

### DETAILED DESCRIPTION OF THE INVENTION

This invention relates to a system and method for ensuring the secure operation of computing devices by detecting and analyzing input data to prevent unauthorized access and protect sensitive information. The primary objective of this invention is to prevent authorized work computers from being remotely accessed and used by unauthorized individuals. The invention uses hardware devices, including vibration sensors, monitoring software, and secure workflows, to monitor, verify, and respond to potentially malicious activities.

The system consists of multiple entities, hardware components, and software layers working together to ensure secure interaction with work computers. The invention ensures that only authorized personnel can interact with the system and prevents unauthorized personnel from accessing sensitive data or performing unauthorized operations remotely.

Key components include: Entities: Authorized personnel (e.g., employees), unauthorized personnel (e.g., freelancers), and the organization managing the system. Hardware Devices: Work computers, personal computers, input devices (e.g., keyboards, mice, touchpads), and vibration sensors. System Layer: Includes operating systems, virtual machines (VMs), virtual desktop infrastructure (VDI), etc., which are used to run software drivers and process input data. Software Layer: Comprises operating system drivers, sensor drivers, input device drivers, and monitoring software used to verify input authenticity and detect anomalies through AI/ML techniques.

### System Architecture

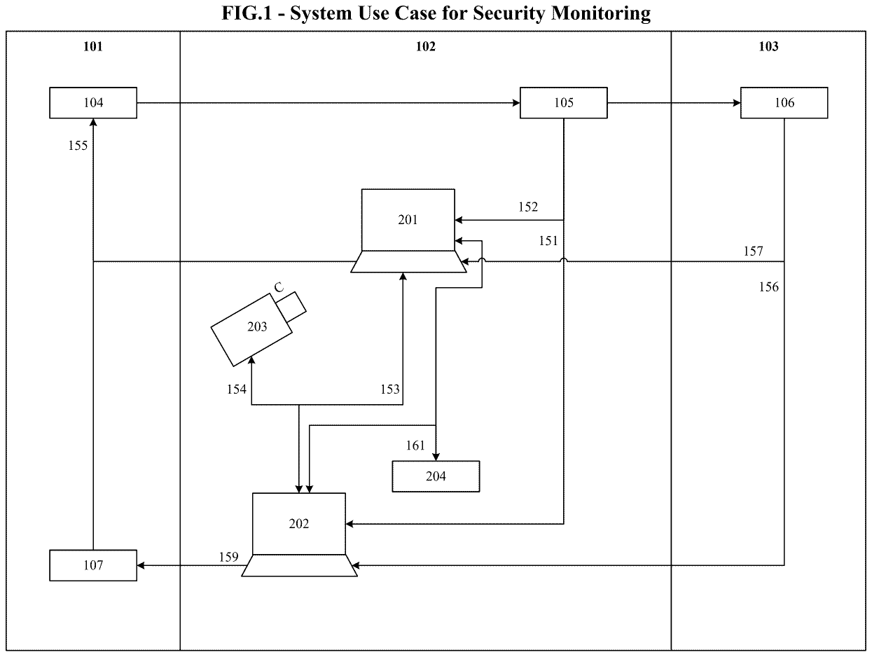

### FIG. 1—System Use Case for Security Monitoring

FIG. 1 illustrates the interactions between entities and hardware devices, as well as the data flow in a typical use case. Below is a detailed description of the steps and components involved: Entity Roles: Entity (101): An organization, institution, or individual that assigns computing resources to authorized personnel, supervised by a manager (104). Authorized Personnel (102): Represented by an employee (105) who uses both the work computer (201) and their personal computer (202). Unauthorized Personnel (103): Represented by a freelancer (106) who gains unauthorized access to the system via remote connections. Hardware and Connections: The work computer (201) is connected to the employee's personal computer (202) through input simulation mechanisms (153). A camera (203) captures visual data from the work computer's screen and transmits it (154) to unauthorized personnel (106). An external/internal vibration sensor (204) monitors input vibrations to verify physical interactions. The sensor (204) can be connected to either 201 or 202. In embodiments employing a dedicated encryption chip, the sensor data is cryptographically secured at the hardware level before being passed along for decryption (401). Workflow: The entity (101) or an authorized representative (e.g., a manager or project owner) assigns the work computer to the employee (105) who sets it up at home. The employee (105) may connect their personal computer to the work computer, which could lead to unauthorized personnel remote access if not properly monitored and controlled. Unauthorized personnel attempt access via the following remote connection methods: Directly connecting to the work computer (106→157). Gaining access through the employee's personal computer and transmitting data to another system (106→156→202→159→107). Remotely manipulating input devices via the employee's personal computer (106→156→202→153/154→203/201). The vibration sensor (204) detects input data (161). A dedicated encryption chip, which may incorporate a Physical Unclonable Function (PUF), prevents employee (105) from plugging the vibration sensor device into an unauthorized device. The vibration sensor (204) also sign the data to ensure its authenticity. The (optionally encrypted) vibration sensor data must be decrypted or verified (401) to confirm authenticity. Work results (155) are sent back to the manager after verification, both from work computer (201) and VM/VDI (107).

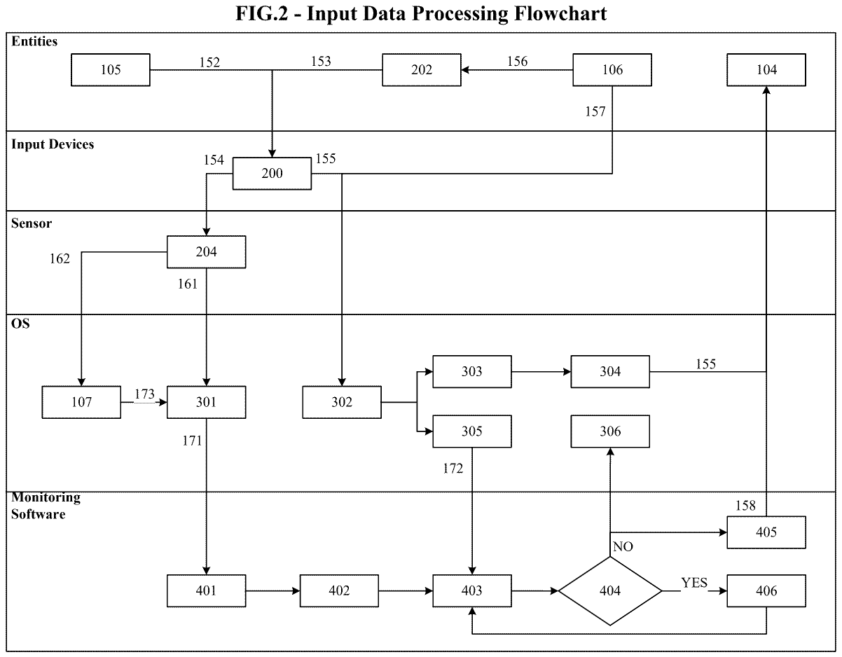

### FIG. 2—Input Data Processing Flowchart

FIG. 2 provides a detailed workflow of the input data processing system. The process starts with input from hardware devices and undergoes verification and anomaly detection through various software layers.

Entity Roles: Authorized Employee (105): Uses physical input devices (200) such as keyboards or mice/touchpads for data input (152). Freelancer (106): Connects remotely (156) to the employee's personal computer (202) and indirectly simulates input device input (153) or directly connects (157) to the work computer. Manager (104): Receives work reports (155) from the employee (105) or warning notifications (158) from the administrator (405).

Input Data Sources: Input Hardware Devices (200): Generate input data (152) transmitted to the system, potentially manipulated through simulated input (153) by the freelancer (106). Vibration Sensor (204): Detects physical vibration input from input devices and transmits it (161) to the sensor driver (301). In embodiments with the encryption chip, the sensor data may be cryptographically protected before or upon leaving the sensor module.

System/Software Processing Layers: Operating System/VM/VDI (300): Provides the runtime environment for drivers and monitors input data processing. Sensor Driver (301): Processes raw or encrypted vibration sensor input data and forwards it to the system. Input Device Driver (302): Interprets input signals from devices. Data Analysis (303): Examines input patterns, generates events, and translates them into system actions (304). Finally, the employee (105) submits work results (155) to the manager (104).

Monitoring Software (400): Sensor Verification (401): Checks the activity and integrity of the vibration sensor data. Input Verification (402): Input verification with cryptographically signed sensor data ensures secure processing. AI/ML Analysis (403): Uses machine learning to analyze input patterns and detect anomalies. Decision Making: Data Analysis Comparison (404): The monitoring software determines appropriate actions based on the analysis. Administrator Notification (405): If input inconsistencies or encryption validation failures are detected, the system locks down (306) and notifies the administrator (405). Continuous Monitoring (406): The monitoring software continuously checks whether the vibration sensor input matches the input device input. Security measures are triggered if the monitoring software (400) detects anomalies from input verification (402) or AI/ML analysis (403). If the physical vibration data does not match the corresponding digital input events captured by the operating system, it will return as failed; otherwise, it will continue.

### Advantages of the Invention

Enhanced Security: The vibration sensor adds a physical authentication layer to ensure there is no unauthorized input remotely. AI/ML analysis detects malicious activity patterns, providing proactive protection. A dedicated encryption chip cryptographically validates the sensor data, preventing tampering or spoofed signals.

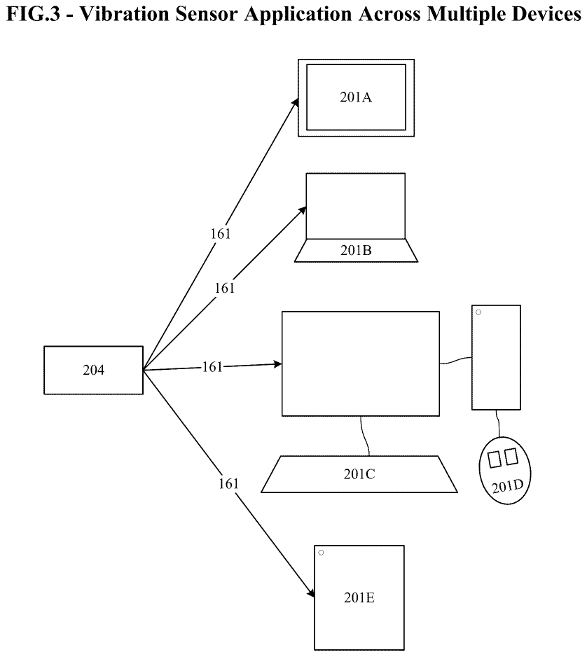

### FIG. 3—Vibration Sensor Application Across Multiple Devices

FIG. 3 illustrates a system architecture where a vibration sensor (204) is utilized to verify user input authenticity across multiple computing devices. The vibration sensor (204) is responsible for detecting mechanical impulses associated with user interactions and transmitting the corresponding data (161) to various connected computing devices.

As shown in FIG. 3, the system comprises multiple components:
1. Vibration Sensor (204): A sensor device that captures vibration signals corresponding to physical interactions with input devices.
2. Computing Devices (201A, 201B, 201C, 201E): Multiple devices, such as a tablet (201A), laptop (201B), desktop computer (201C), and a virtual machine or VDI server (201E), which utilize vibration data for input verification.
3. Peripheral Input Device (201D): An external input device, such as a mouse or keyboard, connected to one of the computing devices.
4. Data Transmission Paths (161): Communication links that transmit the vibration data from the vibration sensor (204) to the computing devices.

In operation, the vibration sensor (204) detects mechanical impulses generated by a user interacting with an input device (201D). These impulses are transmitted as vibration data (161) to computing devices (201A, 201B, 201C, 201E), allowing each device to correlate the received vibration signal with corresponding input events.

By comparing detected vibration signals with digital input events, the system ensures that only physically present users can interact with the computing devices. This prevents unauthorized remote access attempts where a remote user may try to simulate input without actual physical interaction.

The described architecture provides an additional layer of security by verifying user presence based on physical input patterns. If an anomaly is detected—such as input occurring without a corresponding vibration signal—the system may trigger security measures, including locking the computing device (201C) or notifying an administrator.

This invention provides a comprehensive security framework for preventing unauthorized remote access and verifying user authenticity through physical input validation.

32. A method for preventing unauthorized remote access to an authorized computing device, the method comprising: Providing a computing environment assigned by an entity (101) to authorized personnel (102), wherein the computing environment includes at least one computing system or virtual environment (201) and may optionally be accessed through a personal computer (202) ; Receiving user input data from at least one input device (200) capable of generating input signals, said input device including but not limited to keyboards, mice, touchpads, or other interaction mechanisms; Detecting physical vibration signals associated with the user input via at least one vibration sensor (204) that captures mechanical impulses corresponding to the actuation of the input device (200); Preventing unauthorized personnel (106) from remotely simulating input events by ensuring that detected vibration signals and input device signals originate from a physically present user; Processing the user input data using an input driver (302) and providing the processed data to a data analysis module (303); Comparing, at the data analysis module (303), the user input data with the detected vibration signals to determine whether they correlate in time and/or magnitude, indicating a physically generated user action; Verifying the integrity of the sensor (204) and optionally decrypting the user input data within monitoring software (400), wherein the monitoring software applies AI/ML analysis (403) to detect anomalies that signify simulated or unauthorized input; Determining, based on said comparison and AI/ML analysis, whether the input pattern is anomalous and: i. Allowing continued operation if the user input data is verified as corresponding to physical vibration signals, or ii. Locking the computing system (201) and notifying an administrator (405) via a security mechanism (306) upon detecting an anomalous pattern.

33. The method of claim [0032], wherein the vibration sensor (204) comprises any type of mechanical sensor, including but not limited to a MEMS accelerometer, an inertial measurement unit (IMU), or a pressure-sensitive mechanism, for capturing physical interaction data.

34. The method of claim [0032], wherein the monitoring software (400) uses AI/ML-based detection models, including neural networks, support vector machines, or decision trees, to distinguish physically generated inputs from remotely simulated input signals.

35. The method of claim [0032], further comprising comparing a frequency of input events to a frequency of detected vibration signals and flagging any mismatch as indicative of potential remote or automated input sources.

36. The method of claim [0032], wherein the computing environment (201) is hosted on a virtual machine (VM) or virtual desktop infrastructure (VDI) system, and the monitoring software (400) is configured to detect discrepancies between local hardware vibration signals and digitally redirected input events from remote protocols.

37. The method of claim [0032], further comprising using a dedicated encryption chip to cryptographically sign the detected vibration signals before transmission to the monitoring software (400), preventing unauthorized tampering or spoofing of sensor data.

38. The method of claim [0032], wherein the monitoring software (400) applies multi-layered anomaly detection, including: Time correlation analysis between input events and vibration signals; Signature verification of vibration sensor data using a cryptographic mechanism; AI/ML-based behavioral profiling to detect unusual access patterns or input behaviors.
